(19) United States
(12) Patent Application Publication
(10) Pub. No.: US 2015/0016128 A1
(43) Pub. Date: Jan. 15, 2015

(54) METHOD AND SYSTEM FOR CONTROLLING A LIGHT DISTRIBUTION PRODUCED BY MOTOR VEHICLE HEADLAMPS

(71) Applicant: Ford Global Technologies, LLC, Dearborn, MI (US)

(72) Inventors: Gerald DOERNE, Cologne (DE); Christoph SCHLAUG, Ingelbach (DE); Michael KOHERR, Euskirchen (DE)

(21) Appl. No.: 14/315,055

(22) Filed: Jun. 25, 2014

(30) Foreign Application Priority Data
Jul. 9, 2013 (DE) 102013213375.8

(51) Int. Cl. B60Q 1/08

(52) U.S. Cl. CPC B60Q 1/085
USPC 362/465

(57) ABSTRACT

A method and system for controlling the light distribution produced by at least one headlamp of a motor vehicle. A camera system onboard the vehicle images a scene ahead of the vehicle and sends digital files to an image evaluation device operable to detect a traffic indicator, such as a signboard, in the scene and recognize a correspondence between the traffic indicator and a stored pattern. The light distribution produced by the headlamp is automatically controlled based upon the correspondence. Possible light distributions are a normal dipped headlight, a lowered dipped headlight, a raised dipped headlight, an expanded dipped headlight, and a turn light. The light distribution may be further controlled based upon information relating to: current vehicle operating conditions; a presence and/or type of street lighting; a category of the road being driven on; and/or a presence and/or type of middle crash barrier.

### CROSS-REFERENCE TO RELATED APPLICATIONS

This application claims foreign priority benefits under 35 U.S.C. §119(a)-(d) to DE 10 2013 213 375.8 filed Jul. 9, 2013, which is hereby incorporated by reference in its entirety.

### TECHNICAL FIELD

The invention relates to a method and system for controlling the light distribution projected by the headlamps of a motor vehicle.

### BACKGROUND

In the case of classic motor vehicle headlamp units, it is possible to select between different light distributions, in particular “dipped” headlight and “high beam,” in order to adapt to the road being driven on, for example urban road, country road or freeway.

Some modern motor vehicle headlamp units also enable automatic setting of different light distributions. For example, a turn light may be switched on in response to the driver actuating a turn indicator, or a steerable cornering light may be activated when cornering is recognized by means of a steering angle sensor and a speed sensor. In the case of a turn light and/or cornering light, an asymmetric light distribution is provided which better illuminates the curve being driven on or traversed. A further example is an automatic lateral (left and/or right) expansion of the light beam(s) projected by the dipped headlight(s) under specific conditions.

The selection of the light distribution is normally based on information relating to the current driving situation of the vehicle, but not relating to the actual surroundings of said vehicle. This may lead to scenarios in which the illumination is not set optimally, in particular in situations where the driving behavior of the driver is not adapted to the street/road category. Certainly this could be avoided by means of satellite navigation and digital road maps, but not every vehicle has an expensive satellite navigation system, and road maps are not always up to date.

### SUMMARY

In a disclosed embodiment, in the course of the image evaluation, traffic indicators are detected and compared with stored patterns, and, in the case of a recognized correspondence between a detected traffic indicator and a specific stored pattern, a light distribution from a multiplicity of possible different light distributions which is assigned to the stored pattern is automatically set. Here, light distribution is understood as the accumulated beam characteristic of all the light bundles projected by all the headlamps.

Traffic indicators are generally reliable indicators for a light distribution appropriate to the surrounding scenery and, with the aid of present-day image evaluation methods, can be recognized more reliably than can other information relating to the surroundings. Moreover, the disclosed system can be used to detect temporary traffic indicators such as, for example, so-called mobile traffic signboards at construction sites, which are not normally stored in navigation systems, or a warning triangle erected to protect a vehicle that has been abandoned or involved in an accident.

The invention enables the light distribution to be continuously and optimally adapted to the current surroundings during driving, without requiring the driver to become active, and without making excessive demands of his alertness.

In a disclosed embodiment of the invention, the traffic indicators are traffic signboards which are indicators for a light distribution appropriate to the surrounding scenery which are particularly reliable and can be recognized particularly well. However, the invention can also be used to detect, evaluate, and consider other traffic indicators such as, for example, roadway markings which may, for example, indicate speed restrictions or raised pedestrian crossings.

In a disclosed embodiment of the invention, at least five different light distributions of the headlamp are provided, in particular a normal dipped headlight, a lowered dipped headlight, a raised dipped headlight, an expanded dipped headlight and a turn light. It is possible for some of these light distributions to be set at multiple levels or even in an infinitely variable fashion, for example by being able to raise or lower the dipped headlight at many levels or even in an infinitely variable fashion. Moreover, some of said light distributions can be combined with one another, for example turn light with a normal or a raised dipped headlight, and it is also possible to provide a steerable cornering light such that substantially more different light distributions are also possible for the most varied surrounding sceneries.

As mentioned, traffic indicators and, in particular, traffic signboards are reliable indicators for the surrounding scenery, for which reason it is possible to carry out the control of the light distribution of the at least one headlamp only as a function of the result of the image evaluation with respect to traffic indicators. The reliability of the method may be yet further improved when the control of the headlamp light distribution is additionally carried out as a function of information, obtained in the motor vehicle, relating to the current vehicle operating conditions, such as, for example, information relating to the current steering angle, the driving direction, actuation of a turn indicator (blinker), and the current vehicle speed. This combines the advantages of the known automatic light distribution setting with the aid of information relating to the vehicle interior with the advantages of the inventive light distribution setting.

The ability of the disclosed method to adapt may be further improved by controlling the light distribution also as a function of information relating to the surroundings obtained by recognizing the presence and/or the type of street lighting, for example by recognizing and counting street lamps whose presence and, if appropriate, whose number, intervals and brightnesses may be characteristic of specific street categories.

Moreover, the ability of the disclosed method to adapt may be further improved by controlling the light distribution also as a function of information relating to the surroundings obtained by recognizing the category of the road being driven on such as, for example, urban road, country road or freeway with the aid of the appearance thereof.

Moreover, the ability of the disclosed method to adapt may be further improved by controlling the light distribution also as a function of information relating to the surroundings obtained by recognizing the presence of a middle crash barrier with or without dazzle-blocking panels, in order to optimize the light distribution with respect to the risk of dazzling the oncoming traffic.

Exemplary embodiments are described below with the aid of the drawings.

### BRIEF DESCRIPTION OF THE DRAWINGS

FIGS. 1A to 1E show five different light distributions of the headlamps of a motor vehicle on a road; and

FIG. 2 shows an exemplary table with traffic signboards and corresponding light distributions which are switched on, off or over upon recognition of the respective traffic signboard.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The exemplary embodiments are described with the aid of a motor vehicle whose headlamps can be swiveled left/right and/or adjusted in height in stages by means of actuators in order to be able to set a multiplicity of different light distributions. The swiveling and height adjustment can, however, also be carried out at an infinity of levels.

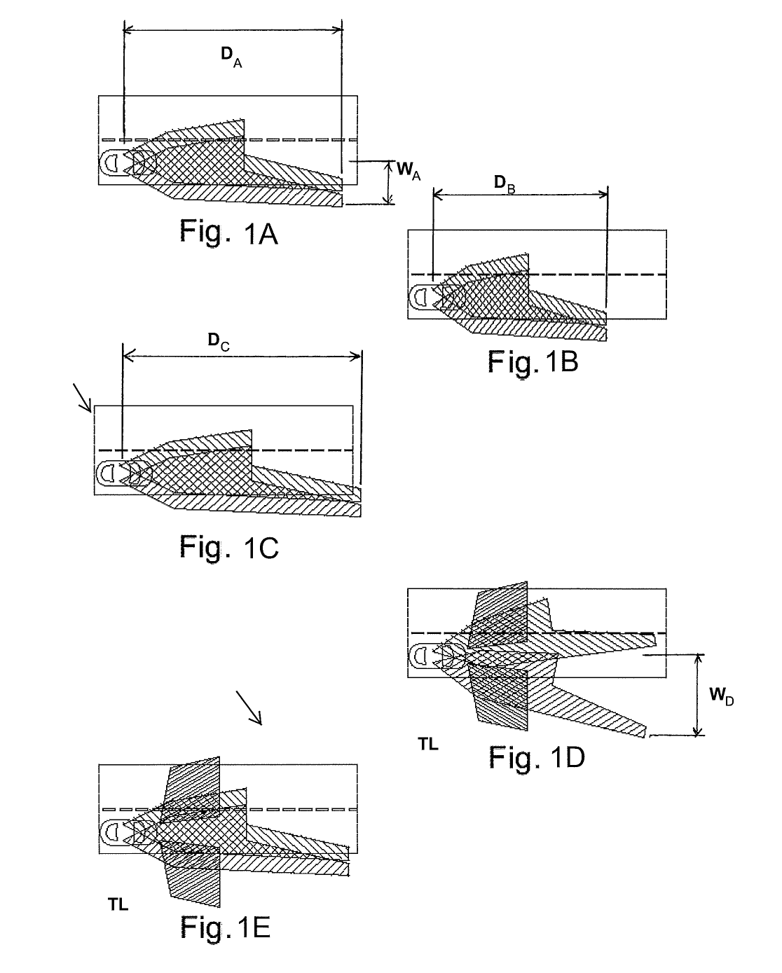

FIG. 1A shows a motor vehicle with a normal asymmetric dipped headlight switched on, for example in a way appropriate on a country road with oncoming traffic, or in a tunnel.

FIG. 1B shows the motor vehicle with a lowered dipped headlight, which illuminates the roadway a shorter distance ahead of the vehicle than does the light distribution of FIG. 1A (D_{A}>D_{B}), and to which a switch may appropriately be made from some other light distribution before the start of a section of the road with a negative gradient so that the oncoming traffic is not dazzled.

FIG. 1C shows the motor vehicle with a raised dipped headlight, which illuminates the roadway a greater distance ahead of the vehicle than the light distribution of FIG. 1A (D_{A}<D_{C}), and to which a switch may appropriately be made, for example at the beginning of a positive gradient, freeway or motor road, if appropriate also on other roads with more than one particular permitted top speed. At the end of a freeway or motor road, the normal setting of the dipped headlight may appropriately be reinstated, unless other present signboards indicate a different setting to be more appropriate.

FIG. 1D shows the motor vehicle with a laterally expanded dipped headlight (W_{D}>W_{A}) combined with a turn light (TL). The light distribution of FIG. 1D should generally respond to a traffic signboard such as, for example, stop, give way, roundabout, start of pedestrian zone, start of 30 speed zone, play street, pedestrian crossing, or school zone. At the end of such a zone, the normal setting of the dipped headlight should gene may appropriately be reinstated, unless other present signboards indicate a different setting to be more appropriate.

FIG. 1E shows the motor vehicle with a normal dipped headlight combined with a turn light (TL). A switchover may appropriately be made to the light distribution of FIG. 1E when a traffic signboard such as, for example, a pedestrian warning sign, a wildlife crossing warning sign or a city/town entrance sign is detected. Upon the detection of a city/town exit traffic signboard, the normal setting of the dipped headlight may appropriately be reinstated, unless other present signboards indicate a different setting to be more appropriate.

The motor vehicle shown in FIGS. 1A to 1E also includes a camera directed forward which detects or images the scene in front of the motor vehicle and sends it in the form of digital images to an image evaluation device. The image evaluation device extracts traffic signboards from the images detected by the camera and compares them with stored patterns of traffic signboards. If a correspondence is recognized between a detected traffic signboard and a specific stored pattern, one of the light distributions shown in FIGS. 1A to 1E which is assigned to the specific stored pattern is automatically set.

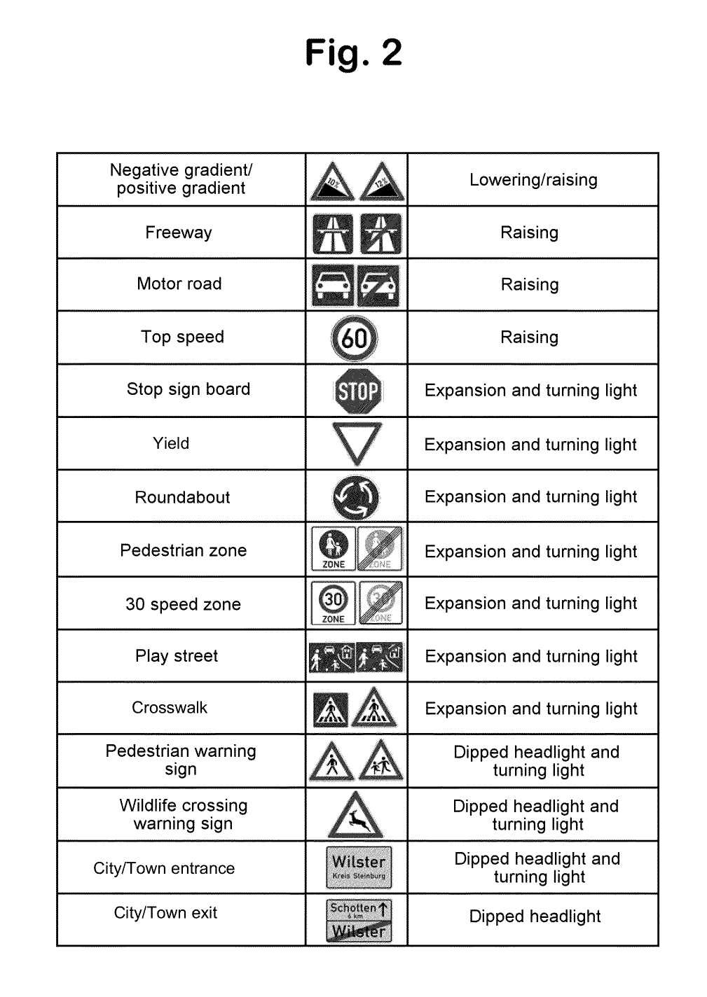

The selection of the light distribution associated with a recognized traffic signboard can be performed using a table such as is illustrated schematically in FIG. 2. For the sake of completeness, in relation to a few categories of streets and zones, the drawing also shows the corresponding signboard indicating the end of a particular zone or area, upon the recognition of which the light distribution specified in the table may be terminated.

In further exemplary embodiments, not provided with Figures, additional information related to the current driving situation may be provided and analyzed to determine which light distribution is to be selected, in particular:
information relating to the current vehicle operating condition, such as the steering angle, the driving direction indicated by actuating a turn indicator, and the current vehicle speed;
number, interval, and brightness of street lamps recognized in the camera images;
category, recognized by means of the camera images, of the road being driven on, for which there are suitable recognition algorithms; and/or
a central crash barrier, recognized in the camera images, with or without dazzle-blocking panels (opaque panels mounted above the crash barrier sufficiently high to block the driver's view of the headlamps of most on-coming traffic).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for controlling light distribution of a motor vehicle headlamp, comprising:
operating a camera system onboard the vehicle to image a scene ahead of the vehicle;
operating an image evaluation device to detect a traffic indicator in the scene and recognize a correspondence between the traffic indicator and a stored pattern; and
automatically controlling a light distribution of the headlamp based upon the correspondence.

2. The method of claim 1, wherein the traffic indicator comprises a traffic signboard.

3. The method of claim 1, wherein the light distribution is produced by activating at least one of a normal dipped headlight, a lowered dipped headlight, a raised dipped headlight, an expanded dipped headlight, and a turn light.

4. The method of claim 1, wherein the light distribution is further controlled based upon information relating to the current vehicle operating conditions.

5. The method of claim 1, wherein the light distribution is further controlled based on information relating to a presence and/or type of street lighting.

6. The method of claim 1, wherein the light distribution is further controlled based on information relating to a category of the road being driven on.

7. The method of claim 1, wherein the light distribution is further controlled based upon information relating to a presence and/or type of middle crash barrier.

8. A system for a motor vehicle comprising:
a camera system onboard the vehicle imaging a scene ahead of the vehicle;
an image evaluation device receiving digital images from the camera system, detecting a traffic indicator in the scene, and recognizing a correspondence between the traffic indicator and a pattern stored in the image evaluation device; and
a headlamp automatically controlled in response to the correspondence to adjust a light distribution produced by the headlamp.
